(19) United States
(12) Patent Application Publication
(10) Pub. No.: US 2015/0379543 A1
(43) Pub. Date: Dec. 31, 2015

(54) AUTOMATIC ASSOCIATION AND TRIGGERS FOR NATURED PAIRINGS OF DEVICES

(71) Applicant: Orbotix, Inc., Boulder, CO (US)

(72) Inventor: William Ronco, Longmont, CO (US)

(21) Appl. No.: 14/315,074

(22) Filed: Jun. 25, 2014

(51) Int. Cl. G06Q 30/02; H04W 4/00

(52) U.S. Cl. CPC G06Q 30/0214; H04W 4/008; H04W 4/005

(57) ABSTRACT

A system and method for associating remote devices and corresponding paired computing devices is disclosed. The system includes a database manager that correlates pairings with logged data in order to determine previous associations and the nature of the detected pairing. Upon determining the nature of a given pairing the database manager performs tasks according to the given pairing. Such tasks can include generating new user profiles, issuing referral certificates, tagging log entries, and issuing value credits for successful referrals.

### BACKGROUND

Remote controlled devices have previously been operated using specialized remote controllers specific to a particular device. With the onset of network technology and software application development (e.g., the development of mobile apps), combinations of remote devices and controllers can be linked.

### BRIEF DESCRIPTION OF THE DRAWINGS

The disclosure herein is illustrated by way of example, and not by way of limitation, in the figures of the accompanying drawings and in which like reference numerals refer to similar elements, and in which:

FIG. 1 is a block diagram illustrating a system for associating connected devices, logging referral certificates, and issuing value credits to user accounts;

FIG. 2 is a flow chart illustrating a method for associating connected devices, correlating referral certificates, and issuing value credits to user accounts;

FIG. 3 is a schematic diagram illustrating the components of an example self-propelled device that is in the form of a spherical self-propelled device;

FIG. 4A is a schematic depiction comprising a self-propelled device and a computing device under control of a user;

FIG. 4B depicts a system comprising a plurality of computing devices and self-propelled devices;

FIG. 4C is a schematic that illustrates a system comprising a computing device and multiple self-propelled devices; and

FIG. 5 is a block diagram that illustrates a computer system upon which examples described may be implemented.

### DETAILED DESCRIPTION

A system and method are provided relating to an association mechanism for links or pairings between remotely operated devices and corresponding controllers for those devices. A software application specific to controlling a remotely operated device (“controller application”) is provided to users over a network. Such a controller application can be downloaded by a user via, for example, an app store, or can be uploaded onto the computing device in a variety of manners. An initial launch of the controller application can be detected and a user account can be created for the user and stored in a user account database managed by the system. The controller application can be launched on a computing device by a user and subsequently paired or otherwise linked with a remotely operated device, such as a self-propelled device.

Once launched, an application-specific user interface is generated on a touch-sensitive display of the user's computing device. The user interface includes graphic controls, such as a steering mechanism, in which the user can provide inputs in order to control the self-propelled device to which the computing device is paired. Such a pairing can be detected by via the network, and the occurrence of the pairing can be logged in an activity log, where a unique identifier for the user's computing device and a corresponding unique identifier for the self-propelled device can be associated. Accordingly, a presumption may be made that the user's computing device and the self-propelled device are associated (e.g., owned by the same user).

Subsequently, a second pairing, made between another computing device and the same self-propelled device, can be detected. This second pairing may be considered a secondary association, in which the original user's self-propelled device is paired with a new user's computing device running the controller application. This pairing can also be recorded in the activity log, and identifiers for the original user, the original self-propelled device, and the new user can be associated. This secondary association can further be reflected in the user accounts, or profiles, of both the original user and the new user. Accordingly, a “referral certificate” can be recorded in the original user's account, since it may be presumed that the original user lent or otherwise provided the original self-propelled device to the new user. Such a referral certificate may be in the form of a simple tag or identification for future reference, or may be in the form of a credit or reward to the original user for instigating the referral. Additionally, a record of the pairing may be noted in the new user's account.

Subsequently, a third pairing, made between the new user and a new self-propelled device, can be detected. This third pairing can also be recorded in the activity log, where identifiers for the new user and the new self-propelled device can be associated. Furthermore, this detected pairing can trigger an update to the user account of the original user. The previous associations can identify that the original user referred the new user to acquire the new self-propelled device. Accordingly, the referral certificate can be endorsed or otherwise validated and the original user account can be credited with a reward, such as a financial reward, user credits, and the like.

In accordance with one or more examples, a method of associating connected devices is disclosed. The method includes detecting, on a first occasion, a first pairing between a first computing device and a first remote device. In response to detecting the first pairing, the system can generate a user profile reflecting an association between the first computing device and the first remote device. Subsequently, on a second occasion, the system can detect a second pairing between a second computing device and the first remote device. In response to detecting the second pairing, the system can tag the user profile to indicate a referral to the second computing device. Further still, on a third occasion, a third pairing between the second computing and a second remote device can be detected by the system. In response to detecting this third pairing, the system can issue a value credit or reward (e.g., monetary reward) to the user profile.

One or more examples described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more examples described herein can be implemented using programmatic modules or components of a system. A programmatic module or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some examples described herein can generally require the use of computing devices, including processing and memory resources. For example, one or more examples described herein can be implemented, in whole or in part, on computing devices such as digital cameras, digital camcorders, desktop computers, cellular or smart phones, personal digital assistants (PDAs), laptop computers, printers, digital picture frames, and tablet devices. Memory, processing, and network resources may all be used in connection with the establishment, use, or performance of any example described herein (including with the performance of any method or with the implementation of any system).

Furthermore, one or more examples described herein may be implemented through the use of instructions that are executable by one or more processors. These instructions may be carried on a computer-readable medium. Machines shown or described with figures below provide examples of processing resources and computer-readable mediums on which instructions for implementing examples can be carried and/or executed. In particular, the numerous machines shown with examples include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smart phones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, examples may be implemented in the form of computer-programs, or a non-transitory computer usable carrier medium capable of carrying such a program.

System Description

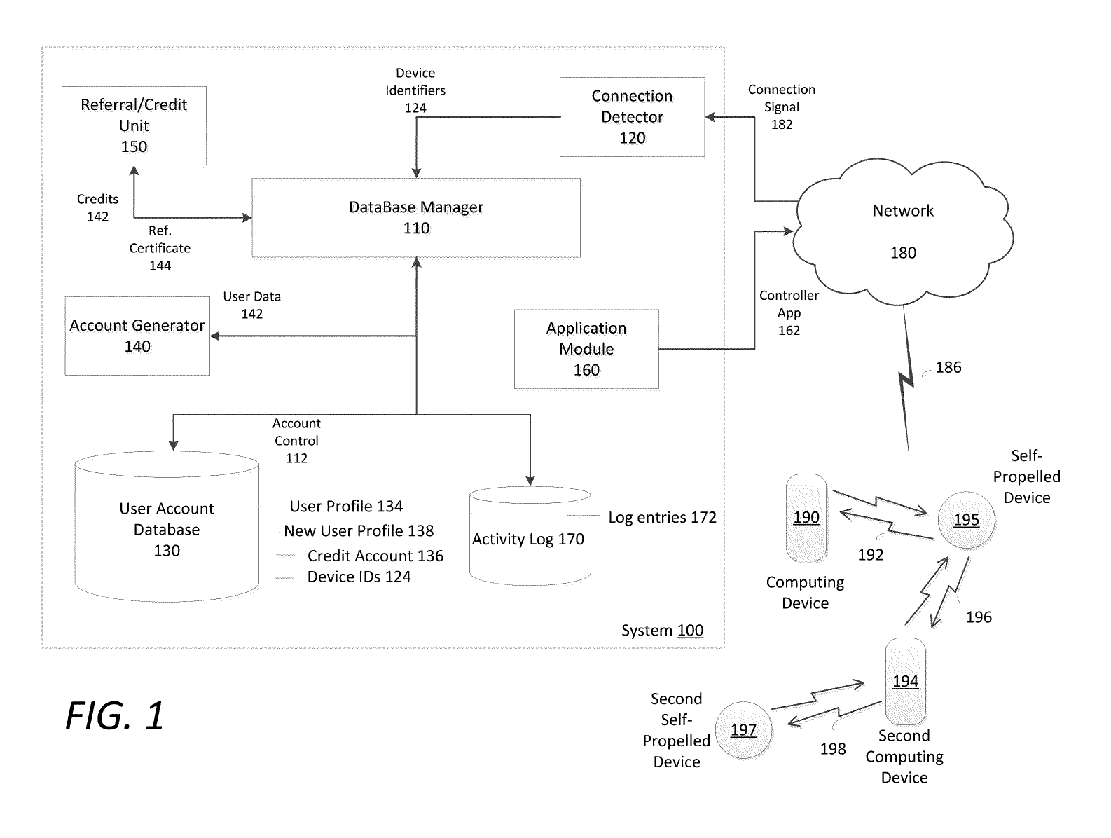

FIG. 1 is a block diagram illustrating a system for associating connected devices, logging referral certificates, and issuing value credits to user accounts. Elements and features described with respect to the system 100 can be included as standalone computing devices, or multiple modules connected through various processors and memory resources. For example, one or more elements of the system 100 can be included with a server-side device, or can be outsourced as a standalone feature external to the system 100. Referring to FIG. 1, a system 100 can include an application module 160 to provide a software application specific to controlling a self-propelled device (“controller application 162”). The controller application 162 can be provided to an application store, which can be accessed by users over a network 180, or can be supplied directly to users as a computer program product. Accordingly, a given computing device 190 can eventually be supplied the controller application 162, which can then be launched and the computing device 190 paired with a self-propelled device 195. Prior to, during, or after the initial launch of the controller application 162, an account, or user profile 134, can be created for the user of the computing device 190. Alternatively, a device pairing 192, in which the computing device 190 is paired with a self-propelled device 195, can trigger the system 100 to create a user profile 134 for the user of the computing device 190.

The computing device 190 is linked 186 to a network 180 via, for example, an IEEE 802.11 (WiFi) protocol. Additionally, the self-propelled device 195 may also be linked 186 to the network 180 (e.g., via WiFi, WiMAX, etc.). The pairing 192 can be made via inductive coupling or “handshake,” a BLUETOOTH link (IEEE 802.15.1 protocol), a WiFi connection, radio link, etc. In variations in which inductive coupling is performed to pair the computing device 190 with the self-propelled device 195, both the computing device 190 and the self-propelled device 195 can include infrastructure for such a coupling. For example, the computing device 190 and the self-propelled device 195 can each include a coil such that within certain proximity, an electromagnetic interaction can take place which establishes a link 192 (e.g., a BLUETOOTH link, radio communication link, etc.) between the devices 190, 195. Accordingly, this inductive pairing can automatically create a BLUETOOTH connection between the computing device 190 and the self-propelled device 195 such that the self-propelled device 195 can be controlled remotely via the controller application 162 launched on the computing device 190.

The user profile 134 can be created upon purchase or initial launch of the controller application 162. Alternatively, the user profile 134 can be created upon an initial pairing 192 between the computing device 190 and the self-propelled device 195. The user profile 134 can be created via user prompts for information, or automatically, and can include information corresponding to the computing device 190, the self-propelled device 195, and/or the user. As an example, the user of the computing device 190 can (i) acquire the self-propelled device 195, (ii) acquire the controller application 162, (iii) launch the controller application 162 on the computing device 190, and (iv) pair the computing device 190 with the self-propelled device 195 in order to control operation of the self-propelled device 195. At any stage in the foregoing, the creation of the user profile 134 can be triggered.

As an example, the pairing 192 between the computing device and the self-propelled device can be detected via a connection detector 120 of the system 100. In such variations, the computing device 190 can communicate a connection signal 182 with the system 100 over the link 186 to the network 180. The connection signal 182 can be detected by the connection detector 120, and can include information corresponding to the computing device 190 and the self-propelled 195. As an example, the initial pairing 192 between the computing device 190 and the self-propelled device 195 can be communicated by way of a connection signal 182 to the connection detector 120. This initial pairing 192 can ultimately trigger the creation of a user profile 134 for the user, or owner, of the computing device 190 and the self-propelled device 195. Information contained in the connection signal 182 can include, for example, unique identifiers 124 for the computing device 190 and the self-propelled device 195. Thus, the user profile 134 for the user of the computing device 190 and the self-propelled device 195 can include at least the device identifiers 124 for both the computing device 190 and the self-propelled device 195. As such, the user profile 134 includes association information indicating that the computing device 190 and self-propelled device 195 are associated with the same user.

Additionally, the user may be associated with any number or combination of computing devices and self-propelled devices. For example, the user may own a smart phone and a tablet computing device, and may wish to operate a single self-propelled device 195 with both the smart phone and tablet. Device identifiers for all three devices may be associated with the user in the user's profile 134. As another example, the user may use a single computing device, such as a smart phone, to operate multiple self-propelled devices 195. Accordingly, the user's profile 134 can be updated to contain information associating the multiple self-propelled devices 195 with the single computing device 190 of the user.

The above associations may be performed by a database manager 110 of the system 100. Upon the initial pairing 192 and the connection signal 182 being detected by the connection detector 120, the database manager 110 can trigger an account generator 140 to create a user profile 134 for the user. In accordance with the above description, the account generator 140 may pull the device identifiers 124 for both the computing device 190 and the self-propelled device 195, and/or various other user data 142 corresponding to the user, such as a username, address, contact information, and the like. The account generator 140 can also establish a credit account 136 in the user profile 134 for the user. The credit account 136 can be issued deposits and/or referral certificates for referrals made by the user. For example, the user may allow a second user's computing device 194 to pair with the self-propelled device 195. Upon this second pairing 196, the database manager 110 can notify a referral/credit unit 150 to tag a referral certificate 144 to the original user's credit account 136.

The database manager 110 is implemented to control much of the operations of the system 100. As such, the database manager 110 receives an input from the connection detector 120 indicating that a connection 192 has been established between a computing device 190 and a self-propelled device 195. This input can simply provide device identifiers 124 for the connected computing device 190 and the self-propelled device 195. Accordingly, if it is an initial connection 192, the database manager 110 can notify the account generator 140 to create a new user profile 134. If it is a subsequent connection between the same computing device 190 and the same self-propelled device 195, the database manager 110 can either take no action, or log the connection in an activity log 170.

The activity log 170 can be included to record some or all connections 192 between computing devices 190 and self-propelled devices 195. Accordingly, the activity log 170 includes entries 172 corresponding to these connections 192. Each entry 172 can contain a time, a date, and the device identifiers 124 for the connecting devices 190, 195. Additionally, an entry 172 can also include a location of a connection, and further information related to the devices 190, 195, the manner of connection 192 (e.g., inductive pairing, direct BLUETOOTH link, etc.), the user of the devices 190, 195, and the like. In such variations, the database manager 110 can perform confirmation look-ups, or retrieve entries 172 in the activity log 170 in order to confirm that certain connections or pairings 192 were made.

A primary function of the database manager 110 includes managing a user account database 130 that includes user profiles 134 for users who have purchased a self-propelled device 195, downloaded or otherwise acquired the controller application 162, launched the controller application 162, and/or paired a computing device 190 with a self-propelled device 195. Upon each detected connection signal 182, the database manager 110 can perform a task relating to a specified user profile 134 in the user account database 130 associated with the specified connection 192, or, depending on the connection, simply log an entry 172 in the activity log 170 indicating that the connection 192 was made.

Accordingly, when a secondary connection 196 is made between a second computing device 194 and the self-propelled device 195, the second computing device 194 can communicate a connection signal 182 that is detected by the connection detector 120, where information corresponding to the second computing device 194 and the self-propelled device 195 can be processed by the database manager 110. This second connection 196 differs from the initial connection 192 in that an unassociated computing device 194 establishes a connection 196 with the self-propelled device 195 that is already associated with a user and the original computing device 190. The database manager 110 can identify such a secondary connection 196 and accordingly communicate with the referral/credit unit 150 to insert or otherwise issue an appropriate certificate in the original user's profile 134. Additionally or as an alternative, the database manager 110 may query the second computing device 194 upon the secondary pairing 196 to determine whether the secondary computing device 194 is associated with a new user, or whether it is simply a new computing device of the original user.

Upon satisfaction that a new user has paired with the original self-propelled device 195, the database manager 110 can communicate the secondary connection 196 to the referral/credit unit 150 so that a proper issuance may be performed. For example, based on the secondary pairing 196, it can be presumed that the original user referred the second user to download the controller application 162 and operate the self-propelled device 195. The referral/credit unit 150 may receive an input from the database manager 110 indicating that a secondary connection 196 has been established between a second computing device 194 and the original self-propelled device 195. This input can cause the referral/credit unit 150 to issue a tag or certificate (referral certificate 144) to the original user's profile 134 in the user account database 130. Accordingly, the original user's profile 134 can be tagged indicating that a referral was made by the original user. Additionally or as an alternative, a log entry 172 corresponding to this secondary pairing 196 can be flagged for future reference to indicate that the secondary pairing 196 is a referral pairing. Thus, device identifiers 124 corresponding to the second computing device 194 and the self-propelled device 195 can be logged to indicate that the pairing 196 was made, and the user profile 134 corresponding to the original user can be tagged.

The referral certificate 144 can be a tag, or alternatively an issued credit 142 to the original user's credit account 136. Such a credit 142 can be in the form of a unique currency associated with a developer of the controller application 162, or can be a cash or other credit or reward for the referral. As a tag, the referral certificate 144 can merely be an indicator to identify that a referral has been made, and that upon a future occurrence, a reward, such as described above, can be issued.

The new user associated with the second computing device 194 can subsequently acquire his or her own self-propelled device 197. A new user profile 138 can be generated by the account generator 140 when the new user (i) pairs with the original self-propelled device 195 (ii) acquires the new self-propelled device 197, (iii) acquires the controller application 162 prior to pairing with the original self-propelled device 195, (iv) launches the controller application 162 on the second computing device 194, or (v) pairs the second computing device 194 with the new self-propelled device 197 in order to control operation of the new self-propelled device 197. In addition to the referral certificate 144 being issued to the original user's profile 134, a referral certificate 144 can also be issued to the new user's profile 138, indicating that the new user was referred to using the controller application 162 in order to operate a self-propelled device. Alternatively, the secondary pairing 196 may result in no consequence for the new user profile 138.

The new user's acquisition of the second self-propelled device 197 can ultimately trigger a reward or credit issuance to the original user's profile 134. As discussed above such a reward or credit 142 can be in the form of a unique currency associated with a developer of the controller application 162, or can be a cash or other credit or reward to the original user for the referral. The trigger for such an issuance can be upon a tertiary pairing 198 between the new user's computing device (second computing device 194), and the newly acquired self-propelled device (second self-propelled device 197). Data indicative of this tertiary pairing 198 can be communicated from the second computing device 194 (or the second self-propelled device 197) to the connection detector 182 over the network 180 via, for example, a WiFi connection 186 between the second computing device 194 and the system 100.

The connection signal 182 corresponding to this tertiary pairing 198 can indicate the device identifiers 124 corresponding to the second self-propelled device 197 and the second computing device 194. The database manager 110 can receive and process an input from the connection detector 120 indicating these device identifiers 124 and subsequently perform a look-up in the activity log 170 to determine whether a flagged entry 172 exists corresponding to the second computing device 194 or the second self-propelled device 197. Upon such a look-up, the database manager 110 will identify the log entry 172 in which the second computing device 194 paired with the original self-propelled device 195. Accordingly, the database manager 110 can then access the original user's profile 134 to issue an appropriate credit or reward from the referral/credit unit 150 to the credit account 136 in the original user's profile 134.

Additionally or as an alternative, upon the detected tertiary pairing 198 between the second computing device 194 and the second self-propelled device 197, the database manager 110 can perform account controls 112 to determine whether device identifiers 124 for either the second computing device 194 or the second self-propelled device 197 have been associated with another user profile. Upon performing such account controls 112, the database manager 110 will identify that a device identifier 124 associated with second computing device 194 has been associated with the original user's profile 134. The database manager 110 can also identify that the original user's profile 134 has been tagged to indicate that the original user referred the new user. Accordingly, the database manager 110 can then trigger the referral/credit unit 150 to issue the proper reward or credit to the credit account 136 in the original user's profile 134.

Additionally or alternatively, upon detection of the tertiary pairing 198, according to executed instructions, the database manager 110 can further issue a credit or reward to a credit account 136 in the new user's profile 138 for acting on the referral. Furthermore, any number of referrals can be made and referral certificates 144 issued depending on such pairings between computing devices and self-propelled devices, and the owners of such devices. Such referral certificates 144 can be validated or “cashed” upon a new acquisition or pairing between a referred computing device and a new self-propelled device.

Methodology

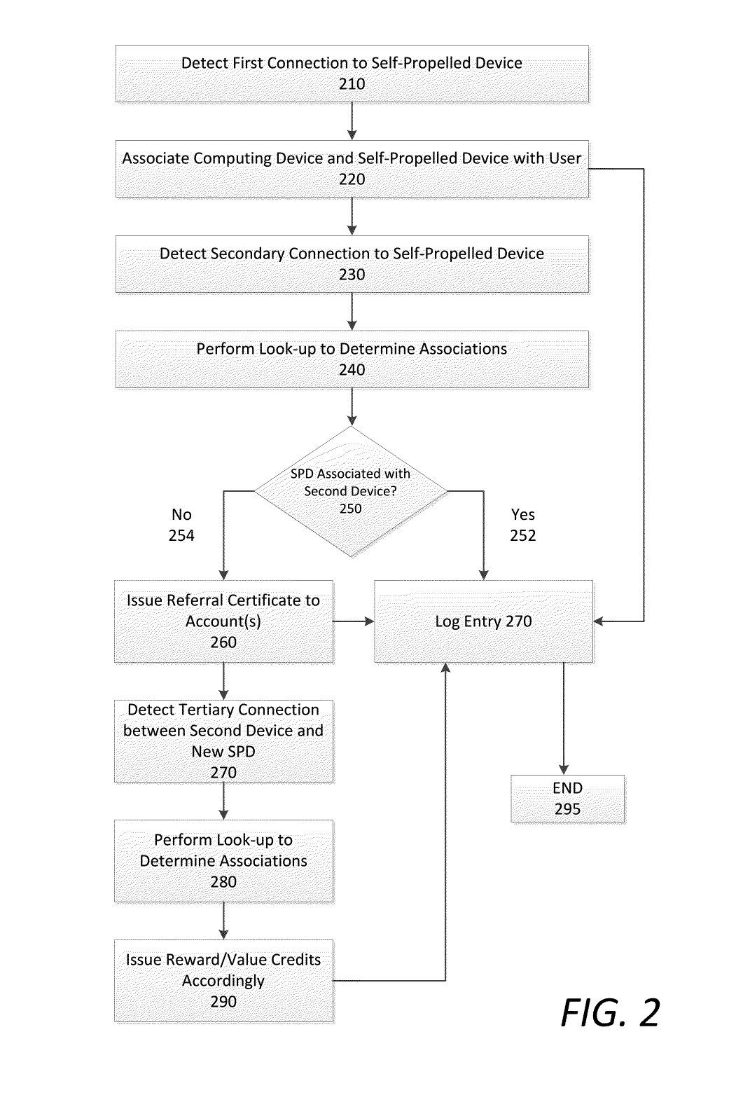

FIG. 2 is a flow chart illustrating a method for associating connected devices, logging referral certificates, and issuing value credits to user accounts. In conjunction with the ensuing description for FIG. 2, reference may be made to various features of FIG. 1. Referring to FIG. 2, the system 100 may detect an initial connection 192 between a first computing device 190 and a self-propelled device 195 (210). The user can launch the controller application 162 on the computing device 190 and then pair the computing device 190 with the self-propelled device 195. Also, this initial connection can be recorded in the activity log 170 as a log entry 172, and/or can trigger the creation of a user profile 134 for a user associated with both the computing device 190 and the self-propelled device 195. Alternatively, a user profile 134 for the user may have already been created as discussed with respect to FIG. 1.

The initial connection 192 can cause the self-propelled device 195, the user's computing device 190, and the user/owner of both devices to be associated (220). Accordingly, device identifiers 124 for the computing device 190 and the self-propelled device 195 can indicate, in the user profile 134, that both devices 190 and 195 are associated with the user. Furthermore, such an association can also be flagged or otherwise indicated in the log entry 172 in the activity log 170 that this particular connection 192 is an initial connection.

Subsequently, the user of both the computing device 190 and the self-propelled device 195 can loan or allow a second user to connect to the self-propelled device 195. This second user can have his or her own computing device 194, and can launch the controller application 162 to pair with the self-propelled device 195. This secondary pairing 196 can be detected by the system 100 (230) and a subsequent look-up can be performed to determine the nature of the pairing 196 (240). This look-up can be performed by, for example, the database manager 110 in one or more of the following ways. In some variations, the database manager 110 can perform a search within the activity log to determine whether the self-propelled device 195 has already been associated with a specified computing device. This search will result in the database manager 110 identifying the self-propelled device 195 being associated with the original user and the original user's computing device 190. Alternatively, the database manager 110 can perform the look-up within the user account database 130 to identify the user profile which indicates the association between the self-propelled device 195 and the original user.

Based on the look-up, the database manager 110 can determine whether the self-propelled device 195 is associated with the second user, or whether it is associated with a different user, such as the original user (250). If the self-propelled device 195 is determined to be associated with the second computing device 194 (252), the database manager 110 can simply log an entry 172 in the activity log 170 indicating that a basic connection has been made, and subsequently end the operation (295).

However, if the self-propelled device 195 is determined to be associated with a different user (254), such as the original user, the database manager 110 can automatically tag the original user's profile 134 to indicate that the original user referred the second user. Additionally or alternatively, the database manager 110 can flag the entry 172 indicating that this secondary connection 196 is a “referred” connection for future reference. Accordingly, a referral certificate 144 can be logged or issued to at least the original user's profile 134 (260). Furthermore, a similar indication or tag can be issued to the second user's profile 138 such that the database manager 110 can perform a future look-up to determine that the second user was referred. After the associations are made and referral certificates 144 issued, the database manager 110 can log the entry (270) and end the operation (295).

A tertiary pairing can then be detected by the system 100 between the second computing device 194 and a new, or second, self-propelled device 197 (270). Accordingly, the database manager 110 can perform a look-up to determine the nature and associations in this pairing (280). Such a look-up can be performed by searching the activity log 170 for identifiers associated with the second computing device 194 or the second self-propelled device 197. Additionally or alternatively, the database manager 110 can check the user account database 130 for user profiles associated with either the second computing device 194 or the second self-propelled device 197. The database manager 110 can then determine that the second computing device 194 had previously paired with the original self-propelled device 195 and that the second user was referred by the original user. Accordingly, the database manager 110 can cause the credit account 136 in the user profile 134 of the original user to be issued a reward or value credit 142 for the successful referral (290). Furthermore, the database manager 110 can also issue the same or a similar reward or value credit 142 to a credit account 136 of the user profile 138 associated with the second user in order to incentivize further referrals. When all credits 142 are issued and associations made, the database manager 110 can log the entry (270) and end the operation (295).

Example Self-Propelled Device

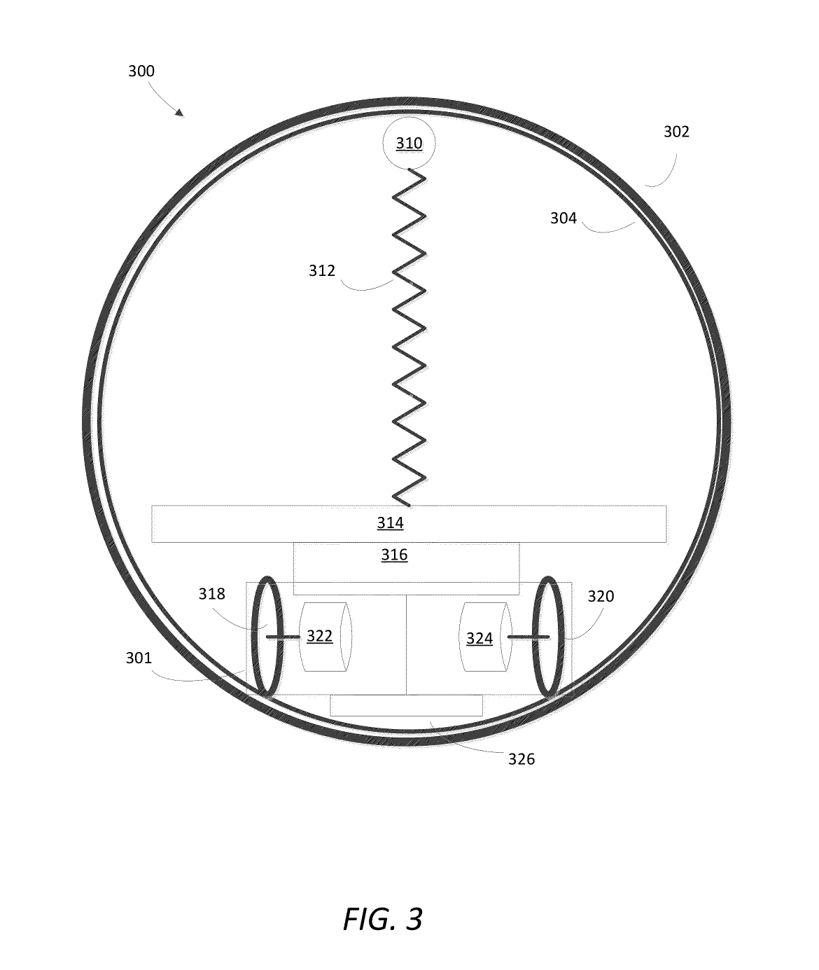

FIG. 3 illustrates an example of a self-propelled device 300, and shows a schematic diagram illustrating the components of a self-propelled device in the form of a spherical self-propelled device. However, variations of the present disclosure are not limited to such devices. Rather, the above-discussed system 100 and method (FIG. 2) can be implemented with respect to any remote device in which pairings or connections are made. Referring to FIG. 3, the self-propelled device 300 can be of a size and weight allowing it to be easily grasped, lifted, and carried in an adult human hand. The self-propelled device 300 includes an outer spherical shell (or housing) 302 that makes contact with an external surface as the device rolls. In addition, self-propelled device 300 includes an inner surface 304 of the outer shell 302. Additionally self-propelled device 300 includes several mechanical and electronic components enclosed by outer shell 302 and inner surface 304 (collectively known as the envelope).

The outer shell 302 and inner surface 304 can be composed of a material that transmits signals used for wireless communication, yet are impervious to moisture and dirt. The envelope material can be durable, washable, and/or shatter resistant. The envelope may also be structured to enable transmission of light and is textured to diffuse the light.

In one variation, the housing is made of sealed polycarbonate plastic. In one example, at least one of the outer shell 302 or inner surface 304 are textured to diffuse light. In one example, the envelope comprises two hemispherical shells with an associated attachment mechanism, such that the envelope can be opened to allow access to the internal electronic and mechanical components.

Several electronic and mechanical components are located inside the envelope for enabling processing, wireless communication, propulsion and other functions (collectively referred to as the “interior mechanism”). Among the components, examples include a drive system 301 to enable the device to propel itself. The drive system 301 can be coupled to processing resources and other control mechanisms, as described with other examples. The carrier 314 serves as the attachment point and support for components of the interior mechanism. The components of the interior mechanism are not rigidly attached to the envelope. Instead, the interior mechanism is in frictional contact with the inner surface 304 at selected points, and is movable within the envelope by the action of actuators of the drive mechanism.

The carrier 314 is in mechanical and electrical contact with an energy storage 316. The energy storage 316 provides a reservoir of energy to power the device 300 and electronics and can be replenished through N inductive charge port 326. The energy storage 316, in one example, is a rechargeable battery. In one variation, the battery is composed of lithium-polymer cells. In other variations, other rechargeable battery chemistries are used.

The carrier 314 can provide the mounting location for most of the internal components, including printed circuit boards for electronic assemblies, sensor arrays, antennas, and connectors, as well as providing a mechanical attachment point for internal components.

The drive system 301 includes motors 322, 324 and wheels 318, 320. The motors 322 and 324 connect to the wheels 318 and 320, respectively, each through an associated shaft, axle, and gear drive (not shown). The perimeter of wheels 318 and 320 are two points where the interior mechanism is in mechanical contact with inner surface 304. The points where wheels 318 and 320 contact inner surface 304 are an essential part of the drive mechanism of the ball, and so are preferably coated with a material to increase friction and reduce slippage. For example, the wheels 318 and 320 can be covered with silicone rubber tires.

In some variations, a biasing mechanism is provided to actively force the wheels 318, 320 against the inner surface 304. In an example provided, the spring 312 and end 310 can comprise a biasing mechanism. More specifically, spring 312 and spring end 310 are positioned to contact inner surface 304 at a point diametrically opposed to wheels 318 and 320. Spring 312 and end 310 provide additional contact force to reduce slippage of the wheels 318 and 320, particularly in situations where the interior mechanism is not positioned with the wheels at the bottom and where gravity does not provide adequate force to prevent the drive wheels from slipping. The spring 312 is selected to provide a small force pushing wheels 318 and 320, and the spring end 310 evenly against inner surface 304.

The spring end 310 is designed to provide near-frictionless contact with inner surface 304. The spring end 310 comprises a rounded surface configured to mirror a low-friction contact region at all contact points with the inner surface 304. Additional means of providing near-frictionless contact may be provided. In another implementation, the rounded surface may include one or more bearings to further reduce friction at the contact point where end 310 moves along inner surface 304. The spring 312 and the spring end 310 are preferably made of a non-magnetic material to avoid interference with sensitive magnetic sensors.

Operation and Communication Links

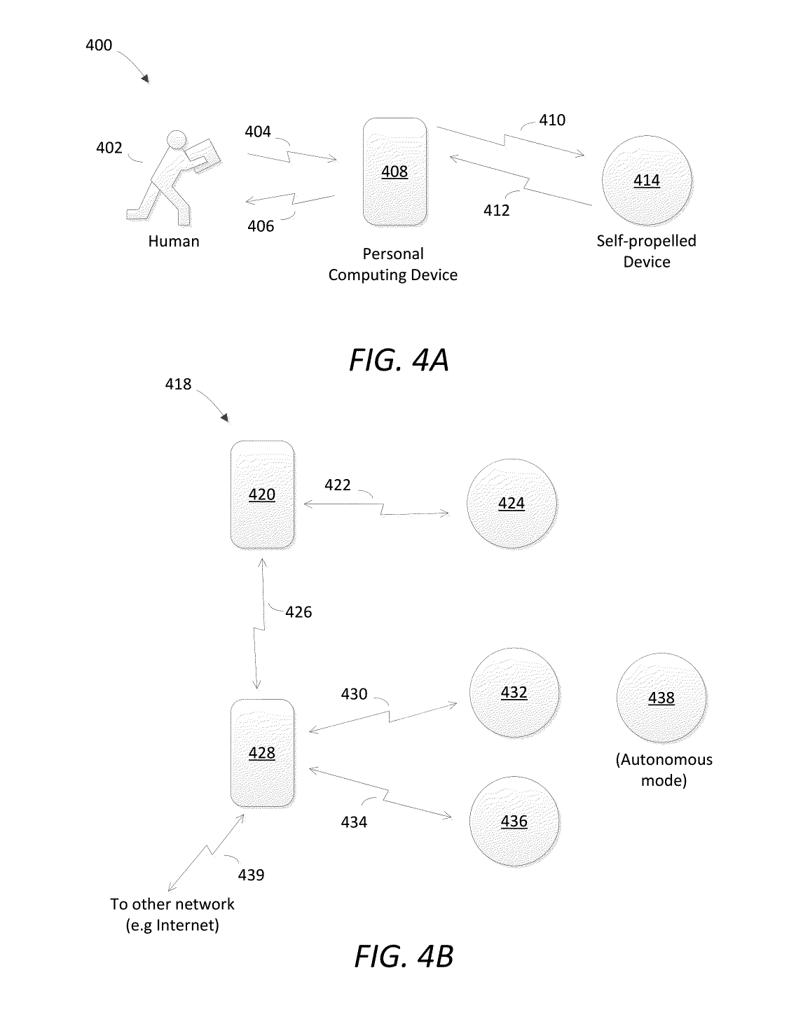

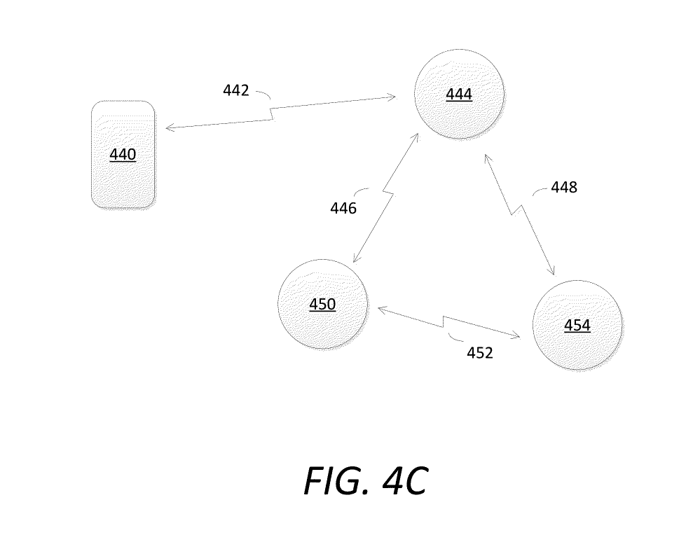

FIG. 4A is a schematic depiction of an example comprising a self-propelled device 414 and a computing device 408 under control of a user 402. More specifically, the self-propelled device 414 can be controlled in its movement by programming logic and/or controls that can originate from the computing device 408. The computing device 408 can wirelessly communicate control data to the self-propelled device 414 using a standard or proprietary wireless communication protocol. In variations, the self-propelled device 414 may be at least partially self-controlled, utilizing sensors and internal programming logic to control the parameters of its movement (e.g., velocity, direction, etc.). Still further, the self-propelled device 414 can communicate data relating to the device's position and/or movement parameters for the purpose of generating or alternating content on the computing device 408. In additional variations, the self-propelled device 414 can control aspects of the computing device 408 by way of its movements and/or internal programming logic.

As described herein, the self-propelled device 414 can have multiple modes of operation, including those of operation in which the device is controlled by the computing device 408, is a controller for another device (e.g., another self-propelled device or the computing device 408), and/or is partially or wholly self-autonomous.

Additionally, the self-propelled device 414 and the computing device 408 may share a computing platform on which programming logic is shared in order to enable, among other features, functionality that includes: (i) enabling the user 402 to operate the computing device 408 to generate multiple types of inputs, including simple directional input, command input, gesture input, motion or other sensory input, voice input or combinations thereof; (ii) enabling the self-propelled device 414 to interpret inputs received from the computing device 408 as a command or set of commands; and/or (iii) enabling the self-propelled device 414 to communicate data regarding that device's position, movement and/or state in order to effect a state on the computing device 408 (e.g., display state, such as content corresponding to a controller-user interface). Additionally or as an alternative, the self-propelled device 414 can further include a programmatic interface that facilitates additional programming logic and/or instructions to use the device. The computing device 408 can further execute programming that is communicative with the programming logic on the self-propelled device 414.

Additionally, the self-propelled device 414 can include an actuator or drive mechanism causing motion or directional movement. The self-propelled device 414 can be referred to by a number of related terms and phrases, including controlled device, robot, robotic device, remote device, autonomous device, and remote-controlled device. Furthermore, the self-propelled device 414 can be structured to move and be controlled in various media. For example, the self-propelled device 414 can be configured for movement in media such as on flat surfaces, sandy surfaces rocky surfaces, etc.

The self-propelled device 414 can be implemented in various forms. In variations, the device 414 can correspond to a radio-controlled aircraft, such as an airplane, helicopter, hovercraft, or balloon. In other variations, the device 414 can correspond to a radio controlled watercraft, such as a boat or submarine. Numerous other variations may also be implemented, such as those in which the device 414 is a robot. Further still, the device 414 can include a sealed hollow body, roughly cylindrical in shape, and capable of directional movement by action of actuators or motors inside the enclosed body.

Continuing to refer to FIG. 4A, the device 414 can be configured to communicate with the computing device 408 using network communication links 410 and 412. For example, link 410 transfers data from the computing device 408 to the self-propelled device 414. Furthermore, link 412 transfers data from the self-propelled device 414 to the computing device 408. Links 410 and 412 are shown as separate unidirectional links for illustrative purposes, however, a single bi-directional communication link can be utilized to perform communication in both directions. Furthermore, links 410 and 412 are not necessarily identical in type, bandwidth or capability. For example, the communication link 410 from the computing device 408 to the self-propelled device 414 can be capable of a higher communication rate and bandwidth compared to the link 412 from the self-propelled device 414 to the computing device 408. In some situations, only one unidirectional link can be established between the computing device 408 and the self-propelled device 414 such that the self-propelled device 414 is capable of being controlled via the computing device 408.

The computing device 408 can correspond to any device comprising at least a processor and communication capability suitable for establishing at least unidirectional communications with the self-propelled device 414. Examples of such devices include, without limitation: mobile computing devices (e.g., multifunctional messaging/voice communication devices such as smart phones), tablet computers, portable communication devices and personal computers. Thus, the computing device 408 may be an IPHONE available from APPLE COMPUTER, INC. of Cupertino, Calif. Alternatively, the computing device 408 may be an IPAD tablet computer, also from APPLE COMPUTER. Alternatively, the computing device 408 may be any of a variety of handheld computing devices and communication appliances executing an ANDROID operating system from GOOGLE, INC. of Mountain View, Calif.

Alternatively, the computing device 408 may be a personal computer, in either a laptop or desktop configuration. For example, the computing device 408 may be a mufti-purpose computing platform running a MICROSOFT WINDOWS operating system, or a LINUX operating system, or an APPLE operating system, configured with an appropriate application program to communicate with the self-propelled device 414. However, in variations, the computing device 408 can be a specialized device, dedicated for enabling the user 402 to control and interact with the self-propelled device 414.

Additionally or as an alternative, multiple types of computing devices can be used interchangeably to communicate with the self-propelled device 414. Thus, the self-propelled device 414 may be capable of communicating and/or being controlled by multiple devices (concurrently or one at a time). For example, the self-propelled device 414 can link with an IPHONE in one session and with an ANDROID device in a later session, without modification of the self-propelled device 414.

Accordingly, the user 402 can interact with the self-propelled device 414 via the computing device 408 in order to control the self-propelled device 414 and/or to receive feedback or interaction on the computing device 408 from the self-propelled device 414. Furthermore, the user 402 may be enabled to specify input 404 through various mechanisms that are provided with the computing device 408. Examples of such inputs include text entry, voice command, touching a sensing surface or screen of the computing device 408, physical manipulations, gestures, taps, shaking and combinations of the above. Additionally or alternatively, the input 404 is made via an application specific to controlling the self-propelled device 414. Such an application can provide a graphical interface that allows for powering and steering the self-propelled device 414.

Further still, the user 402 can interact with the computing device 408 in order to receive feedback 406. The feedback 406 can be generated on the computing device 408 in response to the user input 404. As an addition or alternative, the feedback 406 can also be based on data communicated from the self-propelled device 414 to the computing device 408, regarding, for example, the self-propelled device's 414 position or state. Without limitation, examples of feedback 406 include text display, graphical display, sound, music, tonal patterns, modulation of color and/or intensity of light, haptic, vibrational, and/or tactile stimulation. The feedback 406 can be combined or otherwise synchronized with input that is generated on the computing device 408. For example, the computing device 408 may output content that is modified to reflect position or state information communicated from the self-propelled device 414.

In some examples, the computing device 408 and/or the self-propelled device 414 can be configured such that the user input 404 and the feedback 406 can maximize usability and accessibility for the user 402, who may have limited sensing, thinking, perception, motor skills, or other limited abilities. This can allow users with handicaps or special needs to operate within the system 400 as described.

Example configurations described and illustrated in FIG. 4A are only a few of many possible configurations of networks including a self-propelled device 414 with wireless communication capability. Furthermore, while numerous examples described herein provide for the user 402 to operate or otherwise directly interface with the computing device 408 in order to control and/or interact with the self-propelled device 414, variations to examples described encompass enabling the user 402 to directly control or interact with the self-propelled device 414 without the use of an intermediary device such as the computing device 408.

FIG. 4B depicts a system 418 comprising a plurality of computing devices (420, 428) and self-propelled devices (424, 432, 436, 438). In the examples provided by FIG. 4B, system 418 includes a first computing device 420, a second computing device 428, four self-propelled devices 424, 432, 436, and 438, and communication links 422, 426, 430, 434 and 439. The communication of the first computing device 420 with the self-propelled device 424 using the link 422 is similar to the example depicted in the system 400 of FIG. 4A. However, additional communication can be established between the two computing devices 420, 428 via the network link 426.

Further, the first and second computing devices 420, 428 can optionally control more than one self-propelled device. Further still, each self-propelled device 424, 432, 436, 438 can be controlled by more than one computing device 420, 428. For example, the second computing device 428 can establish multiple communications links, including with the self-propelled devices 432 and 436, and the first computing device 420.

In variations, the first and second computing devices 420, 428 can also communicate with one or more self-propelled devices using a network such as the Internet, or a local wireless network (e.g., a home network). For example, the second computing device 428 is shown to have a communications link 439, which can connect the seconding computing device 428 to an Internet server, a web site, or to another computing device at a remote location. As such, the second computing device 428 can serve as an intermediary between the network source and one or more self-propelled devices. For example, the second computing device 428 can access programming from the Internet and communicate that programming to one of the self-propelled devices.

As an alternative or variation, the computing device 428 can enable a network user to control the second computing device 428 in controlling one or more of the self-propelled devices 432, 436, etc. Still further, the computing device 428 can access the network source in order to receive programmatically triggered commands, such as a command initiated from a network service that causes one or more of the self-propelled devices to update or synchronize using the computing device 428. For example, the self-propelled device 432 can include image capturing resources, and a network source can trigger the computing device 428 to access the images from the self-propelled device, and/or to communicate those images to the network source over the Internet.

In variations, such remote network functionality can alternatively be communicated directly from a network source to the self-propelled devices 424, 432, 436. Thus, the first and second computing devices 420, 428 may be optional. Alternatively, the first and second computing devices 420, 428 may be separated from the self-propelled devices 424, 432, 436 by a network such as the Internet. Thus, the computing devices 420, 428 can alternatively be the network sources that remotely control and/or communicate with the self-propelled devices.

Data communication links depicted in FIGS. 4A, 4B, and 4C are shown as short and direct for purposes of illustration. However, actual links may be much more varied and complex. For example, link 426 connecting the two computing devices 420, 428 can be a low-power wireless link if the computing devices 420 and 428 are in close proximity. However, the computing devices 420, 428 can be spaced a great distance apart (e.g., separated by miles or geographic barriers) so long as suitable network communication can be established. Thus, the link 426, and all other links 422, 430, 434, and 439 can employ a variety of network technologies, including the Internet, World Wide Web, wireless links, wireless radiofrequency communications utilizing network protocol, optical links, or any available network communication technology. The final connection to self-propelled devices 424, 432, 436 and 438 may also be wireless so connecting wires do not restrict mobility.

For example, the communication links 422, 426, 430 and 434 may be based on the BLUETOOTH wireless communication standard. BLUETOOTH is widely available and provides a flexible communication platform for establishing data networks using short-wavelength radio transceivers and data encoding. Furthermore, BLUETOOTH incorporates security features to protect the data sent on the links from unauthorized observers or interference. Alternative wireless communication medium may also be employed, such as wireless USB, WiFi, or proprietary wireless communications. Furthermore, one or more of the communication links 422, 426, 430 and 434 may utilize short-range radiofrequency (RF) communication, and/or line-of-sight communications.

Additionally or alternatively, the communication links may be based on other wireless communication systems, such as Wi-Fi, IEEE 802.11a, 802.11b, 802.11g, 802.11n, 802.11ac, 802.11ad, and/or 802.11ah standards. However, other radio frequency data links may be created using other cellular telephone service or serial communication protocols using radio modems. Alternatively, optical communication links may be employed, including modulating properties of light and LASER beams. Further, any suitable communication technology can be used to form the network links, whether presently known or available in the future. As such, the features described herein are not dependent on any particular networking technology or standard.

Further still, the communication established amongst the devices, such as amongst the computing devices 420, 428 and/or the self-propelled devices 424, 432, 436, can be temporary, flexible, and/or reconfigurable. A resulting network of such devices can be considered an “ad-hoc” network, or alternatively a “piconet” or “personal area network.” In this respect, some implementations provide that the computing device's 420, 428 and the self-propelled devices 424, 432, 436 can be considered nodes of the network, such as an ad-hoc network. In such configurations, network components, topology and communications paths are flexible and can be readily adjusted to accommodate addition or removal of devices, changing communication requirements or channel interference. For example, the self-propelled device 438 in FIG. 4B is shown with no present network connection. However, the self-propelled device 438 may have connected to the network 418 in the past and received instructions to enable it to operate without a persistent network link.

FIG. 4C is a schematic that illustrates a system 468 comprising a computing device 440 and multiple self-propelled devices 444, 450, 454. The computing device 440 can be operable to communicate with one or more self-propelled devices 444, 450, 454. The computing device 440 can communicate commands or other control data, and receive feedback similar to variations described above. The self-propelled devices 444, 450, 454 can be configured to communicate and/or be controlled by the computing device 440. Additionally, the self-propelled devices 444, 450, 454 can be configured to communicate and/or control one another.

In examples shown by FIG. 4C, the computing device 440 can communicate with a primary self-propelled device 444 using communications link 442. The primary self-propelled device 444 can then communicate with another self-propelled device 450 using a separate link 446 and with a third self-propelled device 454 using another separate link 448. Also, the self-propelled devices 450, 454 can communicate with each other using the communication link 452. The computing device 450 can send data to any of the other self-propelled devices 450, 454, using the primary self-propelled device 444 as a relay. Alternatively, the computing device 440 can communicate with the other self-propelled devices 450, 454 directly.

The system 468 can include various configurations. For example, a user can operate the computing device 440 to control the primary self-propelled device 444. Movement of the primary self-propelled device 444 can be communicated both to the computing device 440 and to one or more of the other self-propelled devices 450, 454. Each of the self-propelled devices can be preprogrammed to react in a specific manner based on state or position information communicated from another one of the self-propelled devices. For example, the self-propelled devices 450, 454 can each be operated in a repel mode, so that the movement of the primary self-propelled device 444 (as controlled from the computing device 440) results in a repel motion by the other self-propelled device 450. In other variations, the self-propelled devices 444, 450, 454 may be preprogrammed to maintain a specific distance apart from one another, so that movement by one device automatically causes movement by the other two devices. Still further, the self-propelled devices 444, 450, 454 may be configured so as to perform a variety of activities, such as, for example, (i) one self-propelled device automatically moving when another approaches a threshold distance; (ii) one self-propelled device programmatically moving to bump another self-propelled device; (iii) the self-propelled devices automatically moving in tandem based on input received by each of the self-propelled devices from the other self-propelled devices or from the computing device 440, and/or variations thereof.

The various systems 400, 418, 468 are for illustrative purposes. With any of the systems described, variations include the addition of more or fewer computing devices, and/or more or fewer self-propelled devices. As described with some variations, additional sources or nodes can be provided from a remote network source. Additionally, in some operational environments, the presence of the computing device is optional. For example, the self-propelled devices can be partially or completely autonomous, using programming logic to function.

Hardware Diagram

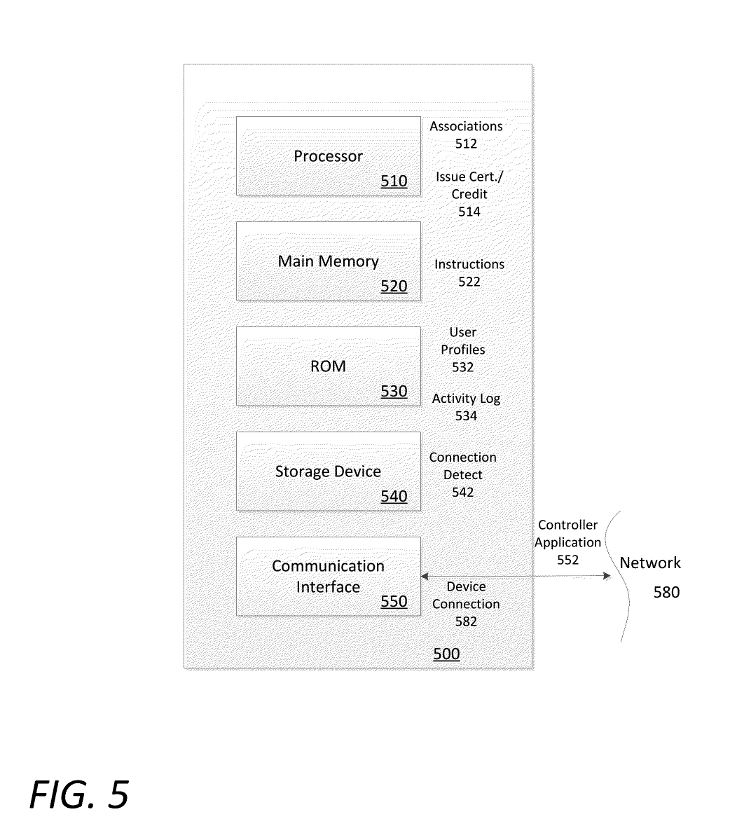

FIG. 5 is a block diagram that illustrates a computer system upon which examples described may be implemented. For example, one or more components discussed with respect to the system 100 of FIG. 1 and the method of FIG. 2 may be performed by the system 500 of FIG. 5. The system 100 can also be implemented using a combination of multiple computer systems as described by FIG. 5.

In one implementation, the computer system 500 includes processing resources 510, a main memory 520, ROM 530, a storage device 540, and a communication interface 550. The computer system 500 includes at least one processor 510 for processing information and a main memory 520, such as a random access memory (RAM) or other dynamic storage device, for storing information and instructions 522 to be executed by the processor 510. The main memory 520 also may be used for storing temporary variables or other intermediate information during execution of instructions to be executed by the processor 510. The computer system 500 may also include a read only memory (ROM) 530 or other static storage device for storing static information and instructions for the processor 510. A storage device 540, such as a magnetic disk or optical disk, is provided for storing information and instructions. For example, the storage device 540 can correspond to a computer-readable medium that trigger connection detection logic 542 for performing operations discussed with respect to FIGS. 1-4.

The communication interface 550 can enable computer system 500 to communicate with one or more networks 580 (e.g., cellular or WiFi network) through use of the network link (wireless or wireline). Using the network link, the computer system 500 can communicate with a plurality of devices, such as the mobile computing devices of the clients and service providers. The computer system 500 can further supply the controller application 552 via the network link to any of the clients. According to some examples, the computer system 500 can receive device connection information 582 from the mobile computing devices of the clients and service providers via the network link. Furthermore, the ROM 530 (or other storage device) can store user profiles 532 which include various user information concerning previous device connections and their nature (e.g., primary, secondary, tertiary connection). The processor 510 can access the user profiles 532 or activity log 534, to determine the nature of a particular connection and make associations 512 accordingly. Once the processor 510 determines the nature of the connection, the processor 510 can issue referral certificates and/or value credits 514 to the appropriate user profile(s) 532.

Examples described herein are related to the use of computer system 500 for implementing the techniques described herein. According to one example, those techniques are performed by computer system 500 in response to processor 510 executing one or more sequences of one or more instructions contained in main memory 520, such as the connection detect 542. Such instructions may be read into main memory 520 from another machine-readable medium, such as storage device 540. Execution of the sequences of instructions contained in main memory 520 causes processor 510 to perform the process steps described herein. In alternative implementations, hard-wired circuitry may be used in place of or in combination with software instructions to implement examples described herein. Thus, the examples described are not limited to any specific combination of hardware circuitry and software.

### CONCLUSION

It is contemplated for examples described herein to extend to individual elements and concepts described herein, independently of other concepts, ideas or system, as well as for examples to include combinations of elements recited anywhere in this application. Although examples are described in detail herein with reference to the accompanying drawings, it is to be understood that this disclosure is not limited to those precise examples. As such, many modifications and variations will be apparent to practitioners skilled in this art. Accordingly, it is intended that the scope of this disclosure be defined by the following claims and their equivalents. Furthermore, it is contemplated that a particular feature described either individually or as part of an example can be combined with other individually described features, or parts of other examples, even if the other features and examples make no mentioned of the particular feature. Thus, the absence of describing combinations should not preclude the inventor from claiming rights to such combinations.

One or more examples described herein provide that methods, techniques and actions performed by a computing device are performed programmatically, or as a computer-implemented method. Programmatically means through the use of code, or computer-executable instructions. A programmatically performed step may or may not be automatic.

One or more examples described herein may be implemented using programmatic modules or components. A programmatic module or component may include a program, a subroutine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Furthermore, one or more examples described herein may be implemented through the use of instructions that are executable by one or more processors. These instructions may be carried on a computer-readable medium. Machines shown or described with FIGS below provide examples of processing resources and computer-readable mediums on which instructions for implementing examples can be carried and/or executed. In particular, the numerous machines shown with examples include processor(s) and various forms of memory for holding data and instructions. Examples of computer-readable mediums include permanent memory storage devices, such as hard drives on personal computers or servers. Other examples of computer storage mediums include portable storage units (such as CD or DVD units), flash memory (such as carried on many cell phones and tablets)), and magnetic memory. Computers, terminals, network enabled devices (e.g., mobile devices such as cell phones) are all examples of machines and devices that utilize processors, memory and instructions stored on computer-readable mediums. Additionally, examples may be implemented in the form of computer-programs, or a computer usable carrier medium capable of carrying such a program.

Although illustrative examples have been described in detail herein with reference to the accompanying drawings, variations to specific examples and details are encompassed by this disclosure. It is intended that the scope of the invention is defined by the following claims and their equivalents. Furthermore, it is contemplated that a particular feature described, either individually or as part of an example, can be combined with other individually described features, or parts of other examples. Thus, absence of describing combinations should not preclude the inventor(s) from claiming rights to such combinations.

While certain examples have been described above, it will be understood that the examples described are by way of example only. Accordingly, this disclosure should not be limited based on the described examples. Rather, the scope of the disclosure should only be limited in light of the claims that follow when taken in conjunction with the above description and accompanying drawings.

What is claimed is:

1. A computer-implemented method of associating connected devices, the method performed by one or more processors and comprising:
detecting, on a first occasion, a first pairing between a first computing device and a first remote device;
in response to detecting the first pairing, generating a user profile reflecting an association between the first computing device and the first remote device;
detecting, on a second occasion, a second pairing between a second computing device and the first remote device;
in response to detecting the second pairing, tagging the user profile to indicate a referral to the second computing device;
detecting, on a third occasion, a third pairing between the second computing and a second remote device; and
in response to detecting the third pairing, issuing a value credit to the user profile.

2. The method of claim 1, wherein the user profile identifies the first computing device and the first remote device with unique identifiers.

3. The method of claim 1, further comprising generating a second user profile corresponding to a second user of the second computing device, the second user profile indicating an association between the second computing device and the second remote device.

4. The method of claim 3, further comprising, in response to detecting the third pairing, issuing a second value credit to the second user profile.

5. The method of claim 3, wherein tagging the user profile includes identifying that a first user of the first computing device has referred the second user to operate the first remote device.

6. The method of claim 5, wherein issuing the value credit includes depositing a monetary reward into a credit account of the user profile.

7. The method of claim 1, wherein the first, the second, and the third pairings are logged in an activity log, wherein a first entry corresponding to the first pairing indicates an initial pairing, wherein a second entry corresponding to the second pairing indicates the referral, and wherein a third entry corresponding to third pairing indicates the issued value credit.

8. A system comprising:
one or more processors; and
one or more memory resources storing instructions that, when executed by the one or more processors, cause the one or more processors to:
detect, on a first occasion, a first pairing between a first computing device and a first remote device;
in response to detecting the first pairing, generate a user profile reflecting an association between the first computing device and the first remote device;
detect, on a second occasion, a second pairing between a second computing device and the first remote device;
in response to detecting the second pairing, tag the user profile to indicate a referral to the second computing device;
detect, on a third occasion, a third pairing between the second computing and a second remote device; and
in response to detecting the third pairing, issue a value credit to the user profile.

9. The system of claim 8, wherein the user profile identifies the first computing device and the first remote device with unique identifiers.

10. The system of claim 8, wherein the instructions, when executed by the one or more processors, further cause the one or more processors to generate a second user profile corresponding to a second user of the second computing device, the second user profile indicating an association between the second computing device and the second remote device.

11. The system of claim 10, wherein the instructions, when executed by the one or more processors, further cause the one or more processors to, in response to detecting the third pairing, issue a second value credit to the second user profile.

12. The system of claim 10, wherein tagging the user profile includes identifying that a first user of the first computing device has referred the second user to operate the first remote device.

13. The system of claim 12, wherein issuing the value credit includes depositing a monetary reward into a credit account of the user profile.

14. The system of claim 8, wherein the first, the second, and the third pairings are logged in an activity log, wherein a first entry corresponding to the first pairing indicates an initial pairing, wherein a second entry corresponding to the second pairing indicates the referral, and wherein a third entry corresponding to third pairing indicates the issued value credit.

15. A non-transitory computer-readable medium storing instructions that, when executed by one or more processors, cause the one or more processors to:
detect, on a first occasion, a first pairing between a first computing device and a first remote device;
in response to detecting the first pairing, generate a user profile reflecting an association between the first computing device and the first remote device;
detect, on a second occasion, a second pairing between a second computing device and the first remote device;
in response to detecting the second pairing, tag the user profile to indicate a referral to the second computing device;
detect, on a third occasion, a third pairing between the second computing and a second remote device; and
in response to detecting the third pairing, issue a value credit to the user profile.

16. The non-transitory computer-readable medium of claim 15, wherein the user profile identifies the first computing device and the first remote device with unique identifiers.

17. The non-transitory computer-readable medium of claim 15, wherein the instructions, when executed by the one or more processors, further cause the one or more processors to generate a second user profile corresponding to a second user of the second computing device, the second user profile indicating an association between the second computing device and the second remote device.

18. The non-transitory computer-readable medium of claim 17, wherein the instructions, when executed by the one or more processors, further cause the one or more processors to, in response to detecting the third pairing, issue a second value credit to the second user profile.

19. The non-transitory computer-readable medium of claim 17, wherein tagging the user profile includes identifying that a first user of the first computing device has referred the second user to operate the first remote device.

20. The non-transitory computer-readable medium of claim 15, wherein the first, the second, and the third pairings are logged in an activity log, wherein a first entry corresponding to the first pairing indicates an initial pairing, wherein a second entry corresponding to the second pairing indicates the referral, and wherein a third entry corresponding to third pairing indicates the issued value credit.
